(19) United States
(12) Patent Application Publication
(10) Pub. No.: US 2026/0166505 A1
(43) Pub. Date: Jun. 18, 2026

(54) SURFACE MODIFIED MEMBRANE FOR LARGE SCALE PRODUCTION OF UNIFORM POLYMER BEADS BY VIBRATION JETTING

(71) Applicant: PUROLITE LLC, King of Prussia, PA (US)

(72) Inventors: Serguei Kosvintsev, Porth (GB); Matthew Donald, Weston-Super-Mare (GB)

(21) Appl. No.: 19/421,576

(22) Filed: Dec. 16, 2025

Related U.S. Application Data
(60) Provisional application No. 63/734,517, filed on Dec. 16, 2024.

(51) Int. Cl. B01J 2/20; B23K 26/382; B23K 26/402

(52) U.S. Cl. CPC B01J 2/20; B23K 26/382; B23K 26/402

(57) ABSTRACT

Membrane emulsification can be performed using a membrane having a microstructured surface. In some examples, a first side of the membrane is contacted with a phase to be dispersed and the second side of the membrane is contacted with a second liquid that is immiscible with the phase to be dispersed. The membrane includes microstructures formed on at least the second side of the membrane, e.g., to control the wettability of the membrane. The phase to be dispersed can be dispersed through a plurality of through holes extending through the membrane to form droplets and polymer beads formed from the droplets.

### RELATED APPLICATION

This application claims priority to U.S. Provisional Application No. 63/734,517, filed on Dec. 16, 2024, the entire contents of which are incorporated herein by reference.

### TECHNICAL FIELD

This disclosure relates to membranes for use in the production of polymeric beads and associated systems and techniques using such membranes.

### BACKGROUND

Membrane emulsification technology allows for the generation of emulsions by a drop-by-drop mechanism through a microporous membrane. For example, an oil-in-water (O/W) or water-in-oil (W/O) emulsion can be formed in which droplets of the disperse phase are formed in an immiscible liquid that is used as the continuous phase. Membrane emulsification can be performed by moving the membrane relative to the continuous phase, e.g., using a moving continuous phase with stationary membrane or moving the membrane within a stationary continuous phase. The relative movement between the membrane and continuous phase can generate a force acting on droplets at the membrane pore level, including a detaching force that drives droplets off the pore and a retaining force holding droplets on the pore. The structure of the membrane and the forces acting on the droplets at the membrane pore level influence droplet development and uniformity.

In general, designers and operators of membrane emulsification technology desire the production of uniform size particles using the technology. For example, when generating spheroidal polymer beads using vibration jetting, it is desirable that the beads are appropriately and uniformly sized. Example uses of such beads include for various chromatographic applications, as substrates for ion exchange resins, seeds for the preparation of larger sized polymer particles, calibration standards for blood cell counters, aerosol instruments, in pollution control equipment, and as spacers for photographic emulsions, among other uses. The uniformity of the beads produced using membrane emulsification are influenced by various factors, including the hydrophobicity and structural wettability of the membrane at the droplet-membrane interface.

### SUMMARY

In general, this disclosure is directed to membranes for use in the production of polymeric beads and associated systems and techniques using such membranes. The membranes can be used for any desired membrane emulsification process, including a process in which an oil phase is to be dispersed into a continuous water phase or in which a water phase is to be dispersed into a continuous oil phase. The membrane can include a first side configured to contact a phase to be dispersed, a second side configured to contact a phase that is immiscible with the phase to be dispersed, and a plurality of through holes extending through the membrane from the first side to the second side. The membrane can also include microstructures formed at least on the second side of the membrane. The microstructures can be configured to increase the contact angle of the phase to be dispersed with the membrane surface, as compared to the contact angle of the phase to be dispersed on the second side of the membrane without the microstructures. This can reduce the wettability of the membrane surface by the phase to be dispersed, increasing the uniformity of the droplets produced using the membrane and, correspondingly, the size uniformity of the polymeric beads formed.

The membrane microstructures can have a variety of different size and shape configurations, which can be controlled to control the wettability of the membrane surface. In some examples, the microstructures may be formed as a laser-induced periodic surface structure. In some examples, the microstructures may be formed as cone-like protrusions. The microstructures may be formed via laser ablation of the surface of the membrane.

Configuring the surface of the membrane with microstructures can allow the membrane to be used in a membrane emulsification process without requiring additional surface coatings on the membrane. For example, an emulsion membrane may typically be coated with a fluoropolymer coating, such as a per- or polyfluoroalkyl substance (PFAS), to increase the hydrophobicity of the membrane. A membrane according to the disclosure may be constructed and used without such a coating, which can be beneficial given increased environmental and regulatory scrutiny around fluoropolymer coatings.

In one example, a method for preparing polymer beads is described that includes contacting a first side of a membrane with a phase to be dispersed and contacting a second side of the membrane with a second liquid that is immiscible with the phase to be dispersed. The example specifies that the membrane includes microstructures formed on the second side of the membrane. The method also includes dispersing the phase to be dispersed through a plurality of through holes extending through the membrane into the second liquid to form a plurality of droplets comprising the phase to be dispersed, where a shear force is provided at a point of egression of the phase to be dispersed into the second liquid. The method further involves forming polymer beads from the plurality of droplets dispersed in the second liquid.

In another example, a method for preparing spheroidal agarose beads is described. The method includes contacting a first side of a membrane with an aqueous agarose solution and contacting a second side of the membrane with a continuous phase. The example specifies that the membrane includes microstructures formed on the second side of the membrane and the second side of the membrane is devoid of any surface coatings. The method further involves dispersing the aqueous agarose solution through a plurality of through holes extending through the membrane into the continuous phase to form a plurality of agarose droplets, where a shear force is provided at a point of egression of the aqueous agarose solution into the continuous phase. The method also includes inducing gelation of the plurality of agarose droplets dispersed in the continuous phase.

In another example, a membrane for use in a membrane emulsification processes is described. The membrane includes a membrane body having a first side configured to contact a phase to be dispersed and a second side opposite the first side configured to contact a second liquid that is immiscible with the phase to be dispersed. The example specifies that the membrane body being devoid of any surface coatings and that microstructures are formed on the second side of the membrane body. The membrane also includes a plurality of through holes extending through the membrane body, the plurality of through holes being configured for dispersing the phase to be dispersed into the second liquid.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a process flow diagram illustrating an example process for generating spheroidal polymer beads that can use a membrane according to the disclosure.

FIG. 2 is a perspective view of an example configuration of a membrane shown in a cylindrical-shaped double-walled configuration.

FIG. 3A conceptually illustrates a membrane exhibiting a water contact angle greater than 90°, providing a hydrophobic surface.

FIG. 3B conceptually illustrates a membrane exhibiting a water contact angle less than 90°, providing a hydrophilic surface.

FIG. 4 is a schematic diagram illustrating an example configuration for laser ablating one or more surfaces of a membrane body to form microstructures on the surface.

FIG. 5 conceptually illustrates an example configuration of a membrane having cone-like protrusions formed thereon.

FIG. 6 conceptually illustrates an example configuration of a membrane 18 having laser-induced periodic surface structures formed thereon.

FIG. 7 is an image of a smooth stainless steel substrate before microstructuring.

FIG. 8 is an image of a stainless steel substrate with a first example set of microstructures formed as laser induced periodic surface structures (LIPSS).

FIG. 9 is an image of a stainless steel substrate with a second example set of microstructures formed as cone-like protrusions (CLP).

FIG. 10 is an image of a stainless steel substrate with a third example set of microstructures formed as laser induced periodic surface structures (LIPSS).

FIGS. 11-14 are images showing the contact angle of water on the substrates of FIGS. 7-10, respectively.

### DETAILED DESCRIPTION

This disclosure relates to systems, devices, and techniques for producing polymer beads of uniform size distribution using membrane emulsification techniques utilizing a membrane with surface modification features. In some examples, a surface of the membrane forming a point of egression between a phase to be dispersed and an immiscible continuous phase is modified with microstructures, such as laser-induced periodic surface structures and/or cone-like protrusions. The microstructure can configure the membrane as a superhydrophobic membrane. The microstructures can reduce the wettability and increase the water contact angle of the surface, increasing the size uniformity of the droplets produced using the membrane, as compared to droplets formed on the same membrane without such microstructures.

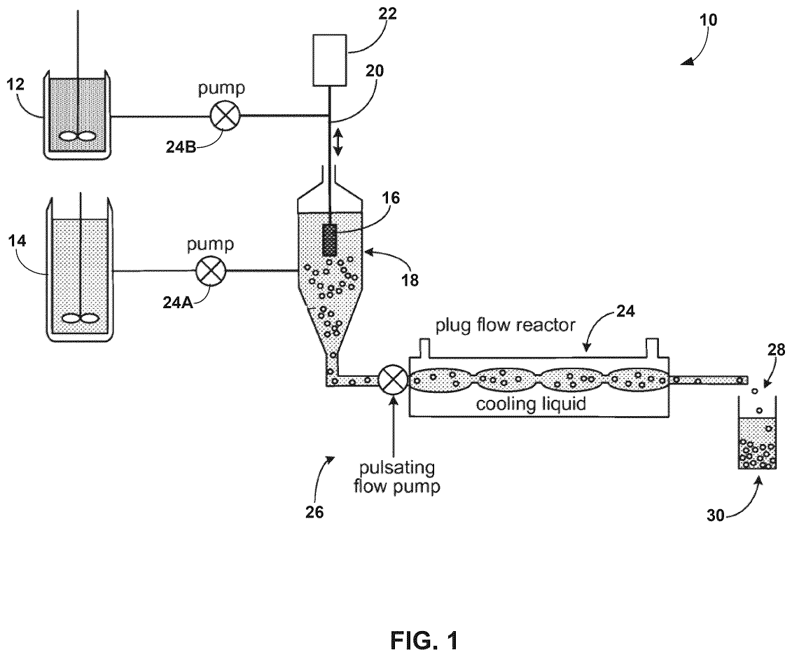

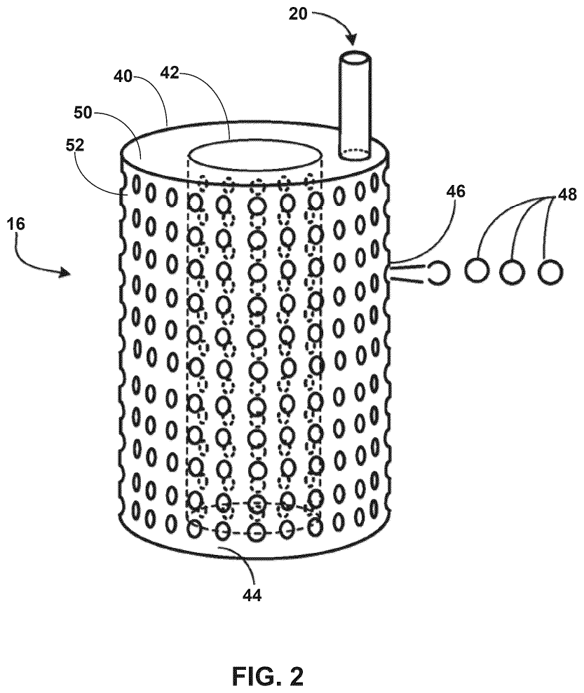

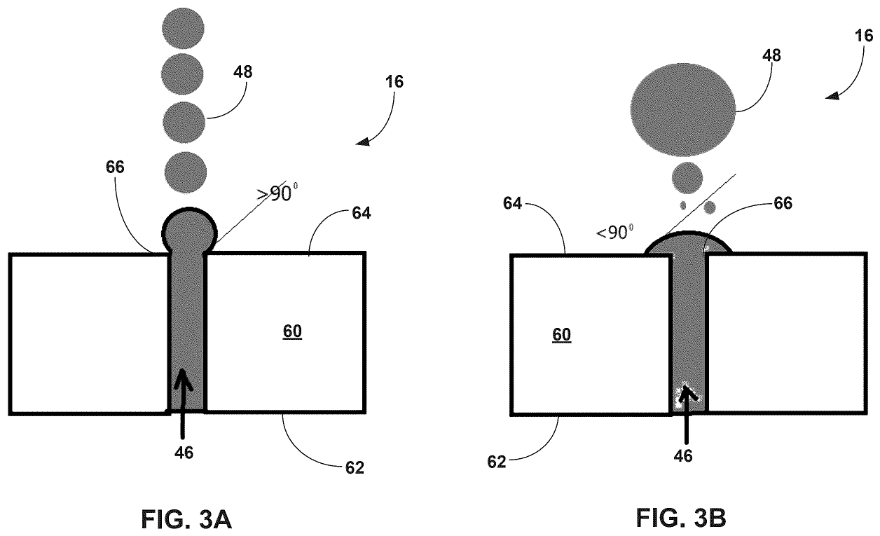

Example membrane surface microstructure configurations that may be used according to the disclosure are described in greater detail with respect to FIGS. 3-6. However, example details of a process that may utilize a membrane according to the disclosure is first described with respect to FIGS. 1 and 2.

FIG. 1 is a process flow diagram illustrating an example process for generating spheroidal polymer beads that can use a membrane according to the disclosure. FIG. 1 particularly illustrates a process for producing spheroidal polymer beads using vibration jetting, although membranes according to the disclosure can be used in other process configurations as will be described herein. In the example of FIG. 1, process 10 includes a first reservoir 12 containing a liquid phase to be dispersed and a second reservoir 14 containing a liquid continuous phase in which the liquid from reservoir 12 is to be dispersed. First reservoir 12 and second reservoir 14 can be implemented using a tank, tote, bottle, and/or other container suitable to receive and hold a liquid.

In the example of FIG. 1, a membrane 16 is positioned in a reactor unit 18. A feed tube 20 fluidly connects membrane 16 to first reservoir 12 containing the liquid phase to be dispersed. Similarly, second reservoir 14 containing the liquid continuous phase is fluidly connected to reactor unit 18. To move membrane 16 relative to the continuous liquid phase in reactor unit 18, process 10 may include a shaker including a vibrator 22, which may incorporate feed tube 20. The vibrator can be connected by electrical contact to a variable frequency (oscillating) electrical signal generator in a manner so that the vibrator 22 vibrates at the frequency generated by the oscillating signal generator.

In operation, the liquid continuous phase from second reservoir 14 can be supplied to reactor unit 18 via pump 24A such that the continuous phase is positioned on and contacts one side of membrane 16. In addition, the liquid phase to be dispersed can be supplied to reactor unit 18 via pump 24B such that the liquid phase to be dispersed is positioned on and contacts another side of membrane 16, e.g., with the liquid pressure on this side greater than the liquid pressure on the opposing continuous phase side to provide a driving force across the membrane. Membrane 16 can have a plurality of apertures extending through the thickness of the membrane. In operation, the pressure differential across the membrane can drive the liquid phase to be dispersed through the holes extending through the membrane and into the continuous phase surrounding the membrane. Movement of membrane 16 relative to the continuous phase via vibrator 22 can generate a shear force at a point of egression where the phase to be dispersed discharges through the apertures of membrane 16 into the continuous phase. This can cause spherical boluses, or droplets, of the phase to be dispersed to shear off at the surface of membrane 16 into the continuous phase.

Reactor unit 18 may be agitated or stirred to prevent significant coalescence or additional dispersion of the droplets during bead formation (e.g., polymerization, gelation). In general, the conditions of agitation may be selected such that the droplets are not significantly resized by the agitation, the droplets do not significantly coalesce in the reactor unit 18, and no significant temperature gradients develop in the suspension and pools of droplets, which may cause size growth.

After formation and emulsification, the droplets comprising the phase to be dispersed can be formed into hardened polymer beads having a spheroidal shape. In some applications, such as when droplets are formed using a monomer phase to be dispersed, the droplets are polymerized to form a resultant polymer bead. In some applications, such as when the droplets are formed using a gel forming hydrocolloid, the temperature of polymer solution is reduced to induce gelation and formation of the polymer bead. In the example of FIG. 1, process 10 is illustrated as including a plug flow reactor 24 downstream of reactor unit 18. A pulsating flow pump 26 can pump the beads formed in reactor unit 18 to plug flow reactor 24, which can reduce the temperature of the beads and thereby cause hardening of the beads over a predetermined time period. The resultant hardened beads 28 can exiting plug flow reactor 24 to be collected in a collection vessel 30.

Membrane 16 can have a variety of different shape configurations. Membrane 16 can be planar (e.g., square, rectangular) and/or arcuate (e.g., circular, oval), and may define multiple wall surfaces. FIG. 2 is a perspective view of an example configuration of membrane 16 in which the membrane is shown in a cylindrical-shaped double-walled configuration. In particular, membrane 16 is illustrated an including an outer cylindrical component 40 with a continuous side wall and an inner cylindrical component 42 with a continuous side wall. The continuous side wall of inner component 42 is spaced inwardly from the continuous side wall of outer component 40 to define an annulus 44 therebetween. Annulus 44 is in fluid communication with feed tube 20 to receive the phase to be dispersed from first reservoir 12.

As shown in FIG. 2, the side wall of inner component 42 is spaced inwardly from the side wall of outer component 40 and may be configured with a constant diameter throughout the height of the inner and/or outer walls. The side wall of inner component 42 and the side wall of outer component 40 can include continuous upper and bottom rims, with the rims joined to form an air-tight compartment between the inner and outer sidewalls. The inside and outside wall of membrane 16 can include a plurality of through holes (also referred to as pores) 46.

During use, the phase to be dispersed enters annular space 44 via feed tube 20 and contacts a first side 50 of a sidewall of outer cylindrical component 40 of membrane 16. A second side 52 of the sidewall of outer cylindrical component 40 of membrane 16 is in contact with the continuous phase within reactor unit 18. Droplets 48 of the phase to be dispersed are formed by and discharged from the through holes 46 into the continuous phase. Configuring membrane 16 as a double walled configuration helps ensure that equal force/acceleration is applied at every through hole 46 on the membrane, helping generate uniform beads.

With further reference to FIG. 1, the composition of the phase to be dispersed and supplied from first reservoir 12 and the continuous phase supplied from second reservoir 14 can vary depending on the composition of the polymer beads being produced using process 10. In general, the phase to be dispersed provides a first liquid and the continuous phase provides a second liquid that is immiscible with the phase to be dispersed. As used herein, reference to a phase to be dispersed being immiscible with a continuous phase means that the solubility of the phase to be dispersed in the continuous phase is 50 ml/L or less, preferably 25 ml/L or less, and more preferably 10 ml/L or less.

In some applications, process 10 is performed to form oil-in-water emulsions using water insoluble monomers or polymers as the phase to be dispersed. The phase to be dispersed includes one or more polymerizable monomers that form a discontinuous phase dispersed throughout an aqueous continuous phase that provide a suspension medium upon the formation of droplets 48 through membrane 16. Polymerizable monomers that can be used include polymerizable monomers or mixtures of two or more copolymerizable monomers that are sufficiently insoluble in a liquid (e.g., a liquid containing suspending agent, such as a surfactant) to form droplets upon the dispersion of the monomer in the liquid. Example polymerizable monomers are monomers polymerizable using suspension polymerization techniques. Such monomers are well known in the art and are described in, for example, E. Trommsdoff et al., Polymer Processes, 69-109 (Calvin E. Schildknecht, 1956).

Specific examples of water-insoluble monomers that can be used in a process using a membrane according to the disclosure include, but are not limited to, monovinylidene aromatics such as styrene, vinyl naphthalene, alkyl substituted styrenes (particularly monoalkyl substituted styrenes such as vinyltoluene and ethyl vinylbenzene) and halo-substituted styrenes such as bromo- or chlorostyrene, polyvinylidene aromatics such as divinylbenzene, divinyltoluene, divinyl xylene, divinyl naphthalene, trivinylbenzene, divinyl diphenyl ether, divinyl diphenyl sulfone and the like; halo olefins, particularly the vinyl halides such as vinyl chloride; esters of a, β-ethylenically unsaturated carboxylic acids, particularly acrylic or methacrylic acid, such as methyl methacrylate and ethyl acrylate; vinyl acetate, and mixtures thereof. Monovinylidene aromatics, such as styrene or a mixture of styrene with a monoalkyl substituted styrene; polyvinylidene aromatics, such as divinylbenzene; esters of a, β-ethylenically unsaturated carboxylic acid, such as methyl methacrylate or combinations thereof, such as mixtures of styrene and divinylbenzene or styrene, divinylbenzene and methyl methacrylate are preferred; and any combination thereof.

In one specific example, a monomer mixture include styrene and divinyl benzene, alone or in combination with a porogen. As used herein, the term “porogen” is defined as a material that is capable of forming pores. Suitable porogens include, for example, aliphatic alcohols such as methyl isobutyl carbinol and isobutyl alcohol.

In some applications, process 10 is performed to form water-in-oil emulsions using water soluble monomers or polymers as the phase to be dispersed. The phase to be dispersed can include one or more polymerizable monomers that form a discontinuous phase dispersed throughout an oleaginous continuous phase that provide a suspension medium upon the formation of droplets 48 through membrane 16. In these examples, the phase to be dispersed can include one or more copolymerizable monomers (e.g., mixtures thereof), mixtures of one or more copolymerizable monomers and/or a hydrocolloid (such as dextrose and agarose, (polysaccharides)), and/or other gel forming compounds (such as PEG, PVA) with a non-polymerizable material (e.g., an inert porogenic or pore-forming material, prepolymer, or the like).

A variety of polymerizable water-soluble monomers may be used as the phase to be dispersed. The water-soluble monomers can be monomers that form an aqueous solution in water, where the resulting solution is sufficiently insoluble in one or more other continuous phase suspension liquids, generally a water-immiscible oil or the like, such that the monomer solution forms droplets upon its dispersion in the liquid. Example water-soluble monomers that can be used as the phase to be dispersed include monomers that can be polymerized using a conventional water-in-oil suspension (that is, inverse suspension) polymerization techniques such as described by U.S. Pat. No. 2,982,749, including ethylenically unsaturated carboxamides such as acrylamide, methacrylamide, fumaramide and ethacrylamide; aminoalkyl esters of unsaturated carboxylic acids and anhydrides; ethylenically unsaturated carboxylic acids, e.g., acrylic or methacrylic acid, and the like; and combinations thereof. In some examples, one or more monomers selected for use are ethylenically unsaturated carboxamides, particularly acrylamide, and ethylenically unsaturated carboxylic acids, such as acrylic or methacrylic acid.

In additional examples, hydrocolloids and/or gel forming compounds can be used as the phase to be dispersed. An example of such a compound is agarose, which forms an aqueous solution in water. Agarose beads are useful as providing a base for example in chromatography media as agarose is resistant to acids, bases, and solvents, is hydrophilic, and has high porosity and a large number of hydroxyl groups for functionalization. Other example hydrocolloids include chitin, pectin, gelatin, gellan, cellulose, alginate, carrageenan, starch, xanthan gum, and the like, and combinations thereof. Other hydrogel forming polymers that can be used as the phase to be dispersed include gelating synthetic polymers such as PVA, (polyvinyl acetate), PVP (polyvinyl pyrrolidone), PEG (polyethylene glycol), PLA (polylactic acid), PLGA (poly(lactic-co-glycolic) acid), and the like and combinations thereof. In each case, the phase to be dispersed may be sufficiently insoluble in one or more other continuous phase suspension liquids (e.g., a water-immiscible oil or the like), such that the compound solution forms droplets upon its dispersion in the liquid. Water soluble hydrocolloids and gel forming compounds in the phase to be dispersed can be formed into a gel using any means well described in the literature and using techniques well known in the art. Subsequent crosslinking of the gel beads can be performed using techniques well known in the art.

The amount of the bead-forming material present in the phase to be dispersed (e.g., monomer, hydrocolloids, hydrogel forming polymer) may vary. In some examples, the phase to be dispersed includes a sufficient amount of liquid to solubilize the bead-forming material. In some examples, the amount of the bead-forming material present in the phase to be dispersed is less than 80 vol % of the total volume of the phase to be dispersed, such as less than 70 vol %, less than 60 vol %, less than 50 vol %, or less than 40 vol %. For example, the amount of the bead-forming material present in the phase to be dispersed may be within a range from 30 vol % to 50 vol % of the total volume of the phase to be dispersed.

After dispersing the phase to be dispersed through the plurality of through holes extending through membrane 16 into a second liquid (which may be referred to as the continuous phase liquid and/or suspension phase liquid) to form a plurality of droplets, the droplets can be formed into hardened polymer beads. The droplets can be formed into hardened polymer beads through various mechanisms, which can vary depending on the type of compound(s) used in the phase to be dispersed. When using a hydrocolloids and/or gel forming compounds, the temperature of the polymer solution can be reduced to induce gelation and formation of the polymer bead. When using a monomer, the monomers can be polymerized using free radical initiation by UV light or heat, or a combination of these methods. Accordingly, chemical radical initiators may be included in the phase to be dispersed, such as persulfates, hydrogen peroxides, and/or hydroperoxides. When used, the ratio of organic initiator to dry monomer may be within a range from 0.1 wt % to 8 wt %, or from 0.5 wt % to 2 wt, such as from 0.8 wt % to 1.5 wt %. The monomer phase can also include monomers which can undergo polymerization through alternate polymerization routes, including, but not limited to, alternate addition polymerization mechanisms or condensation polymerization.

The liquid or suspension phase that forms the continuous phase in which the phase to be dispersed is, in fact, dispersed can be a liquid immiscible with the phase to be dispersed (e.g., specifically the bead-forming material present in the phase to be dispersed). When the phase to be dispersed includes a water-soluble bead-forming material (e.g., monomer, hydrocolloids, gel forming polymer), a water-immiscible oil can be used as the suspension phase. Such water-immiscible oils include, but are not limited to, halogenated hydrocarbons such as methylene chloride, liquid hydrocarbons, preferably having about 4 to about 15 carbon atoms, including aromatic and aliphatic hydrocarbons, or mixtures thereof such as heptane, benzene, xylene, cyclohexane, toluene, mineral oils and liquid paraffins. When the phase to be dispersed includes an oil-soluble bead-forming material (e.g., monomer), the suspension phase can be water or mixtures of water with one or more water-miscible organic liquids such as lower alkyl alcohols such as methanol or butanol.

In some examples, a ratio of the viscosity of the dispersed phase to the viscosity of the continuous phase is in the range from 1.5:1 to 100:1, preferably from 2:1 to 10:1. Such ratios can provide optimized conditions for jetting, avoiding the generation of very small drops when the viscosity ratio is small or below 1, and helping to effectively control the jetted droplet size.

Example viscosity modifiers that may be used in an aqueous continuous phase include one or more of polyvinylalcohol, polyvinylpyrrolidone, polyvinylcaprolactam, polyacrylic acid, polydimethyldiallyl ammonium chloride, hydrolyzed poly(styrene-co-maleic anhydride), hydrolyzed poly(methylvinylether-co-maleic anhydride), and combinations thereof. Examples of viscosity modifiers that may be used with a water immiscible oil continuous phase include, but are not limited to, ethyl cellulose.

The continuous phase may contain a suspending agent. Examples of suspending agents known to those skilled in the art are surfactants with an HLB (hydrophilic-lipophilic balance) of below 5 for a water-in-oil emulsion and greater than 10 from an oil-in-water emulsion. Other additives in the suspension phase such as surfactants, buffers, and/or inhibitors can also be employed. The suspending agent may be selected to form a Pickering emulsion and/or electrostatic stabilization.

In operation, the phase to be dispersed, which can include a phase containing of one or more co-polymerizable monomers, a hydrocolloid (such as dextrose and/or agarose, (polysaccharides)), and/or other gel forming compound (such as PEG, PVA), in each case optionally with a non-polymerizable material (e.g., an inert porogenic or pore-forming material, pre-polymer, or the like) can be introduced to feed tube 20 via first reservoir 12. The material is conveyed via feed tube 20 into (e.g., filling) annulus 44 of membrane 16. The phase to be dispersed can be fed into feed tube 20 at a rate effective such that the phase to be dispersed is forced through pores 46 of membrane 16 into second liquid phase supplied from second reservoir 14 at a rate sufficient to form jets having flow characteristics to form a plurality of dispersed phase droplets 48. The dispersed phase droplets are generated directly into reactor unit 18.

As the phase to be dispersed from first reservoir 12 jet flows into the continuous phase or suspension phase liquid from second reservoir 14 in reactor unit 18, the jet can be excited at a frequency which breaks the jet into droplets. Membrane 16 can be excited using suitable conditions so that substantially uniform sized droplets are prepared. The term “substantially uniform” is meant that droplets exhibit a particle size distribution having a coefficient of variance (i.e., the standard deviation of the population divided by the population mean) of less than 30%, such as less than 25%, less than 20%, less 15%, or less than 10%. In some examples, the droplets exhibit a uniformity coefficient “UC” that is defined a D60/D10 ratio (calculated by dividing the droplet diameter at which 60% of the droplets are smaller (D60) by the droplet diameter at which 10% of the droplets are smaller (D10)), is less than 1.30, such as less than 1.20, less than 1.15, or less than 1.10.

The particular conditions at which the droplets are formed can depend on a variety of factors, including the desired size and uniformity of the resulting droplets and the resulting spheroidal polymer beads. In general, the dispersed droplets may be prepared to have a coefficient of variance of particle size distribution of less than about 20%, such as less than about 15%, or less than 10%. After forming the dispersed phase droplets, the subsequent polymerization or gel formation of the dispersed phase can be performed using conditions that do not cause significant coalescence or additional dispersion and that will result in the formation of spheroidal polymer beads having a particle size distribution. The coefficient of variance of the particle size distribution may be less than about 20%, such as less than about 15%, or less than 10%, optionally in combination with a UC less than 1.30, such as less than 1.20, or less than 1.15, or less than 1.10.

Spheroidal polymer beads produced using process 10 can have a volume average particle diameter (the mean diameter based on the unit volume of the particle) between about 1 μm to about 300 μm, such as between about 10 μm to about 250 μm, or about 35 μm to about 180 μm, or about 40 μm to about 180 μm, or about 100 μm to about 160 μm. The volume average particle diameter can be measured by any conventional method, for example, using optical imaging, laser diffraction or electrozone sensing. Electrozone sensing involves the analysis of particle samples immersed in a conducting aqueous solution. Within the solution an anode and a cathode are formed in the shape of an orifice. The particles are pumped through the orifice by pressure. Each particle displaces some amount of liquid as it passes through the orifice and causes a disruption in the electric field. The extent of the disruption corresponds to the size of the particle, and by measuring the number and size of the changes in impedance, it is possible to track particle distribution. The particle diameter may also be measured using optical microscopy or by employing other conventional techniques such as those described in U.S. Pat. No. 4,444,961.

In process 10 in the example of FIG. 1, vibrator 22 can be implemented using any means which oscillates or vibrates at a frequency capable of exciting the dispersed phase jet so that the dispersed phase jet is broken into droplets. Vibrational excitation can cause a substantially uniform shear force across the membrane at a point of egression of the phase to be dispersed into the continuous phase. The shear force can interrupt the flow of the phase to be dispersed through the through holes 46 extending through membrane 16 creating droplets. The shear force may be provided by rapidly displacing membrane 16 by vibrating, rotating, pulsing or oscillating movement. The direction of shear may be substantially perpendicular to the direction of egression of the phase to be dispersed through the pores. Having the pore opening 46 transverse to the oscillating force can provide sufficient vibration acceleration to break the jets formed at the pore opening into droplets. The frequency of vibration of membrane 16 can vary and, in some examples, is within a range from 10 Hz to 20,000 Hz, such as 20-100 Hz. Vibrational amplitudes may be within in a range of about 0.001 mm to about 70 mm.

Membrane 16 can include any means through which the phase to be dispersed can be passed under conditions such that a jet or plurality of jets of the phase to be dispersed is formed having laminar flow characteristics. Although membrane 16 can be or include a plate or similar device having a plurality of through holes 46, membrane 16 may be implemented to include a double walled can-shape enclosing an annulus as discussed above with respect to FIG. 2. Membrane 16 may also be in the form of a candle, spiral wound, or flat.

Membrane 16 can include from about 100 through holes per cm² to about 40,000 through holes per cm² of the membrane body, such as from about 1,500 through holes per cm² to about 4,000 through holes per cm². The shape of through holes 46 can vary and may, for example, be circular (cylindrical) and/or conical. Through holes 46 may be fabricated by any conventional method, including drilling or electro-forming. The diameter of through holes 46 may be within a range of about 1 μm to about 100 μm, such as from about 20 μm to about 60 μm. For non-circular through holes 46 or through holes of varying diameter (e.g., conical shaped holes), the diameter refers to the cross-section of the opening having the smallest cross-sectional size. The diameter of each opening may primarily be determined by the desired size of the droplets size. Typically, target droplet sizes may vary from about 5 to about 300 μm, such as from about 25 to about 120 μm, or from about 40 to about 110 μm.

The plurality of through holes 46 in membrane 16 can be spaced a distance apart from each other so that the formation of the uniformly sized droplets and the stability of the resulting droplets are not affected by the laminar jet and droplet formation of an adjacent jet. In general, interactions between the droplets formed from adjacent jets may be insignificant when a passage is spaced at a distance of at least about 1.2 to 40 times the diameter of each opening apart from the nearest passage, when the distance is measured from the center of each passage.

As initially discussed above membrane 16, can be configured with microstructures formed on one or more sides of the membrane to control the wettability of the surface and the resultant uniformity of droplets and polymer beads formed through discharge of the phase to be dispersed through the plurality of through holes 46. In general, surface wettability can be characterized by the contact angles of a water droplet on a solid surface, is used to describe the ability of a water droplet in maintaining contact with the solid surface. Generally, if the water contact angle is smaller than 90°, the solid surface is considered hydrophilic and if the water contact angle is larger than 90°, the solid surface is considered hydrophobic.

FIGS. 3A and 3B are conceptual illustrations of an example body 60 of membrane 16 defining a through hole 46. Body 60 may define outer wall 40 of the double-walled can membrane configuration of FIG. 2 although can be implemented in other configurations as discussed herein. In either case, body 60 can define a first side 62 that contacts the phase to be dispersed and a second side 64 opposite the first side that contacts a second liquid (the continuous or suspension phase) during use of membrane 16. Through hole 46 defines a point of egression 66 where the phase to be dispersed exits the through hole 46 into the second liquid and is sheared into a droplet. FIG. 3A conceptually illustrates second side 64 exhibiting a water contact angle larger than 90°, providing a hydrophobic surface that helps define uniform, consistent droplets 48 discharging from the through hole (when using an aqueous phase to be dispersed). By contrast, FIG. 3B conceptually illustrates second side 64 exhibiting a water contact angle less than 90°, providing a hydrophilic surface that results in wetting of surface at the point of egression 66 and inconsistent droplet formation (when using an aqueous phase to be dispersed).

Second side 64 of membrane body 60 may traditionally be made of or defined by a low surface energy material such as a fluorinated polymeric coating (e.g., a per- or polyfluoroalkyl substance (PFAS)), to increase the hydrophobicity of the membrane. In accordance with applications of the present disclosure, however, at least second side 64 of membrane body 60 can have a high contact angle with the phase to be dispersed, controlled through the formation of microstructures. The microstructures formed on one or more sides (surfaces defining the side) of membrane body 60 may be subsequently coated with one or more polymeric layers and/or other surface modifying coatings. Alternatively, one or both of first side 62 and second side (e.g., at least second side 64) of membrane body 60 having microstructures may be devoid of any surface coatings applied on, over, and/or under the microstructures (polymeric and/or non-polymeric surface coatings).

In some applications, microstructures may be formed on second side 64 of membrane body 60 that is configured to contact the continuous/suspension phase during operation of membrane 16. First side 62 that is configured to contact the phase to be dispersed during operation of membrane 16 may or may not have microstructures formed on the surface. Typically, first side 62 may be a planar surface without formed microstructures since the benefits of wettability modification are exhibited at the point of egression 66 through holes 46 rather than the point of ingression. In either case, first side 62 and/or second side 64 (e.g., all surfaces of membrane body 60) may be devoid of any applied surface coatings (or at least of any fluorinated coatings (e.g., PFAS) coatings applied to the one or more surfaces). It can be beneficial to exclude any fluorinated coatings from membrane 16 given increased environmental and regulatory concerns around the use of fluorinated coatings.

In general, the microstructures formed on membrane body 60 (e.g., second side 64 of the membrane body) can be configured (e.g., sized, shaped, positioned) to increase the contact angle of the phase to be dispersed with the portion of the membrane surface on which the microstructures are formed compared to the contact angle of the phase to be dispersed with the portion of the membrane surface without the microstructures. For example, the microstructures can be configured such that second side 64 of membrane body 60 exhibits a water contact angle greater than 90 degrees, preferably greater than 120 degrees, more preferably greater than 150 degrees. The water contact angle of the surface can be measured according to ISO 19403, specifically ISO 19403-1:2017 and 19403-2:2017.

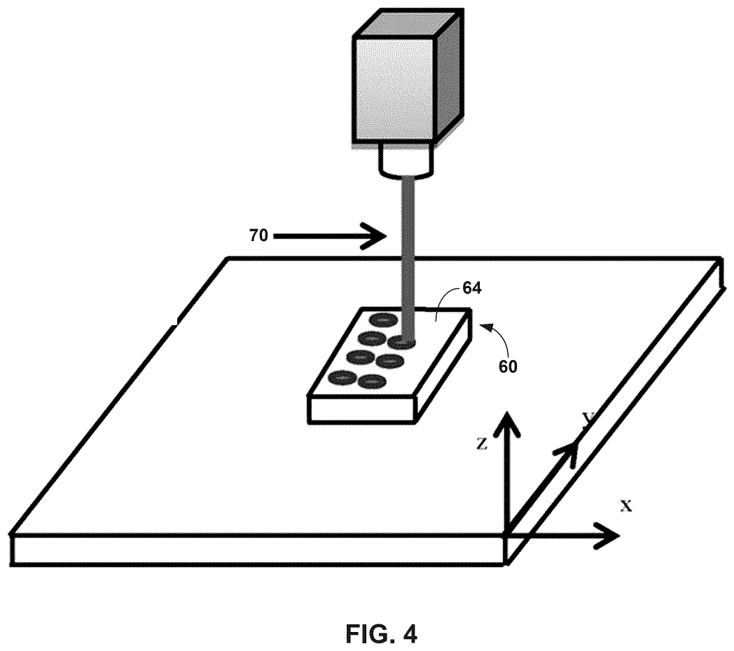

To form microstructures on at least second side 64 of membrane body 60, second side of the membrane body can be laser ablated. FIG. 4 is a schematic diagram illustrating an example configuration for laser ablating one or more surfaces of membrane body 60 to form microstructures on the surface. A laser beam 70 can be passed over one or more surfaces of membrane body 60 under controlled conditions to form microstructures having a target size, shape, and position. In some examples, the microstructures may be formed via ultra-short pulsed laser machining, e.g., using femtosecond laser ablation or nanosecond laser ablation. Different microstructures like cones, laser induced periodic surface structures (LIPSS), thermal bumps, and/or cone-like protrusion (CLP) can be formed on and/or in second side 64 of membrane body 60 depending on the laser parameters and on the optical and physical properties of the material forming membrane body 60.

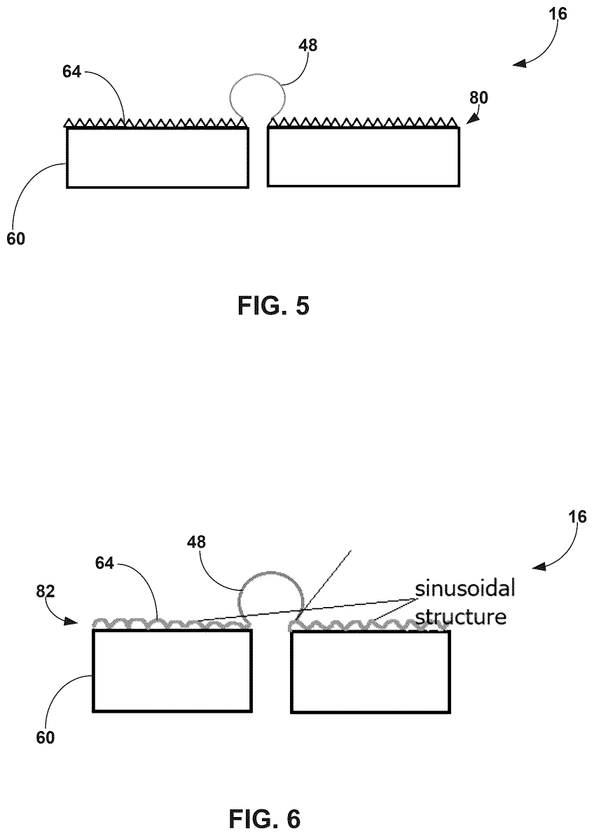

In some applications, second side 64 of membrane body 60 is laser ablated under controlled conditions to form cone-like protrusions. FIG. 5 conceptually illustrates an example configuration of membrane 16 where second side 64 of membrane body 60 has cone-like protrusions 80 formed thereon. Additionally or alternatively, second side 64 of membrane body 60 may be laser ablated under controlled conditions to form laser-induced periodic surface structures (LIPSS). Laser-induced periodic surface structures, which are often referred to as ripples, can be generated by irradiation with linearly polarized radiation. LIPSS can be produced in a single-stage process or multi-stage process. LIPSS can present as a surface relief composed of (quasi-) periodic lines, which exhibit a correlation to the wavelength and polarization of the radiation. FIG. 6 conceptually illustrates an example configuration of membrane 16 where second side 64 of membrane body 60 has laser-induced periodic surface structures 82 formed thereon, with the illustrated example particularly showing an example sinusoidal structure although not being limited to such a configuration.

While the size and configuration of each microstructural feature may vary, in some examples, the formed microstructures have an average height (peak to trough) less than 1000 nm, such as less than 500 nm, less than 100 nm, less than 50 nm, or less than 10 nm.

Membrane body 60 itself can be formed of a variety of different materials, including metal, glass, plastic or rubber. In some applications, membrane body 60 may be substantially metallic or wholly metallic. For example, membrane body 60 may be fabricated from a chemically-resistant metal such as a noble metal, nickel, stainless steel, and/or combinations thereof.

Before supplying the phase to be dispersed through the plurality of through holes 46 of membrane 16, the microstructures on the surface of the membrane may be prewetted. If using membrane 16 to form a water-in-oil emulsion, microstructures on the surface of membrane 16 may be naturally wetted with the oil continuous phase (containing one or more wetting agents, such as a surfactant) as the membrane contacts the continuous phase in reactor unit 18 prior to jetting the phase to be dispersed through the through holes.

However, if using membrane 16 to form an oil-in-water emulsion, the microstructures on the surface of membrane 16 may be controllably wetted with a hydrophilic surfactant to decrease the water contact angle on the second side 64 of the membrane before jetting oil phase to be dispersed. For example, membrane 16 may be soaked in a hydrophilic surfactant or supehydrophilisation of the microstructured surface of the membrane to enhance the uniformity and formation of hydrophobic drops in the oil-in-water emulsion. A hydrophilic surfactant is a water-soluble surface-active molecule that has a hydrophilic (polar) head and a hydrophobic (apolar) tail and, in some cases, the hydrophilic surfactant used to prewet membrane 16 before jetting may have a hydrophilic-lipophilic balance (HLB) greater than 5, such as a HLB greater than 10.

Microstructured membranes according to the disclosure can have controlled surface wettability to promote the formation of uniform spheroidal droplets and resultant polymer beads. Use of microstructuring can obviate the need for coating the membrane with a surface-modifying coating while still delivering the performance characteristics of such coated membranes.

The following examples may provide additional details about microstructured membranes according to the disclosure.

### EXAMPLES

A series of microstructured membrane surfaces were manufactured with different microstructuring and the wettability performance of the microstructured membrane surface evaluated. A control sample and three microstructured were evaluated using scanning electron microscopy at 2750 times magnification and a 15 kV accelerating voltage.

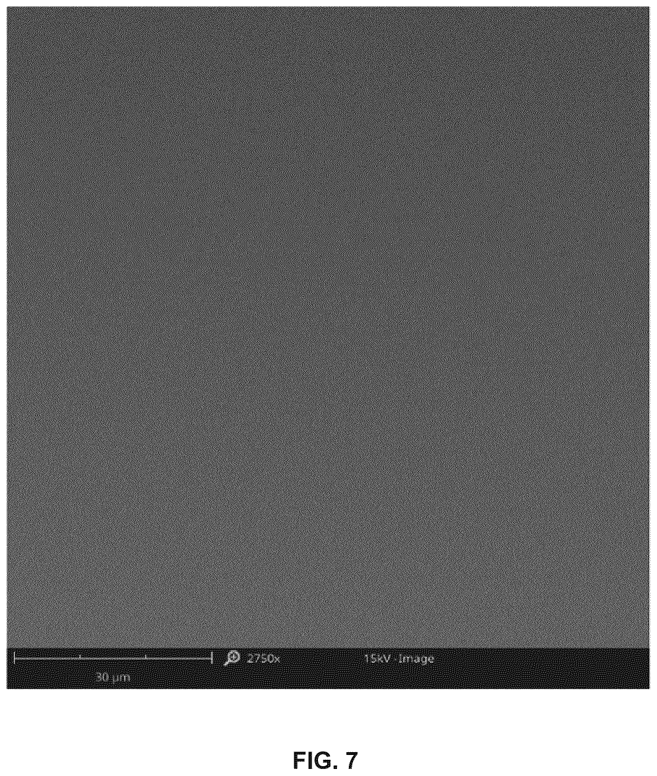

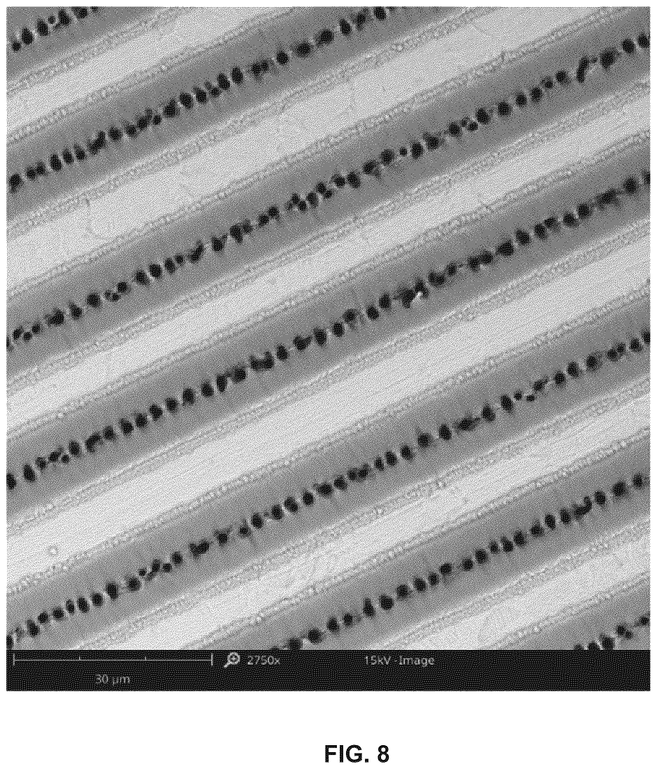

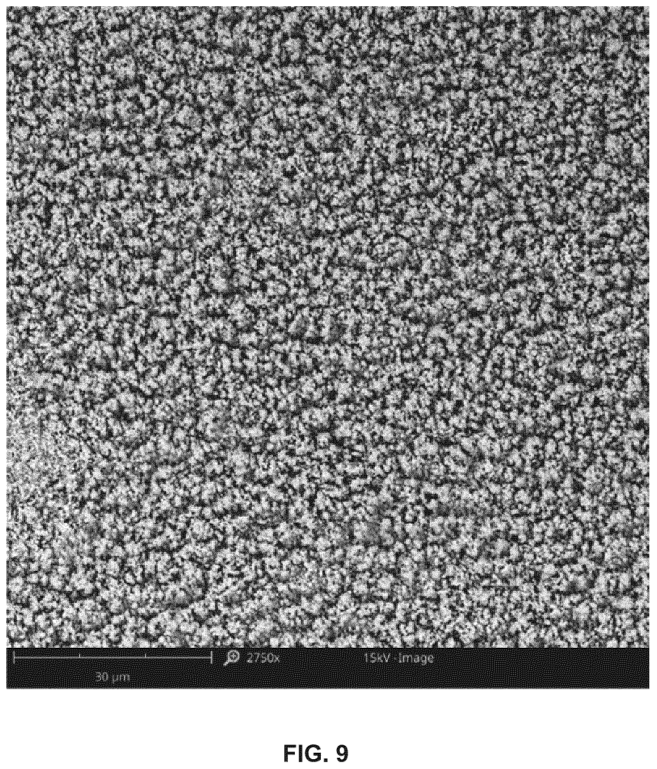

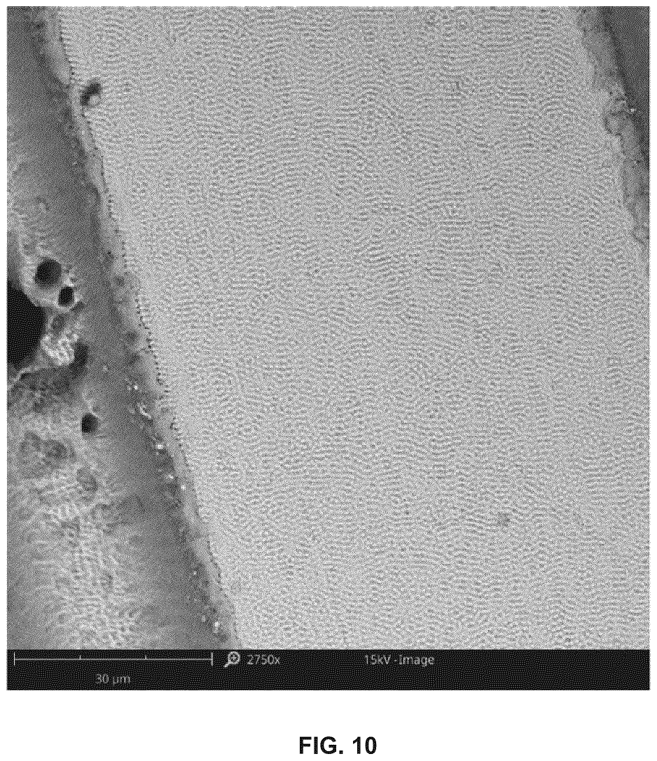

FIG. 7 is a SEM image of a smooth stainless steel substrate before microstructuring. FIG. 8 is a SEM image of a stainless steel substrate with a first example set of 10 μm microstructures formed as laser induced periodic surface structures (LIPSS). FIG. 9 is a SEM image of a stainless steel substrate with a second example set of microstructures formed as cone-like protrusions (CLP). FIG. 10 is a SEM image of a stainless steel substrate with a third example set of microstructures formed as laser induced periodic surface structures (LIPSS).

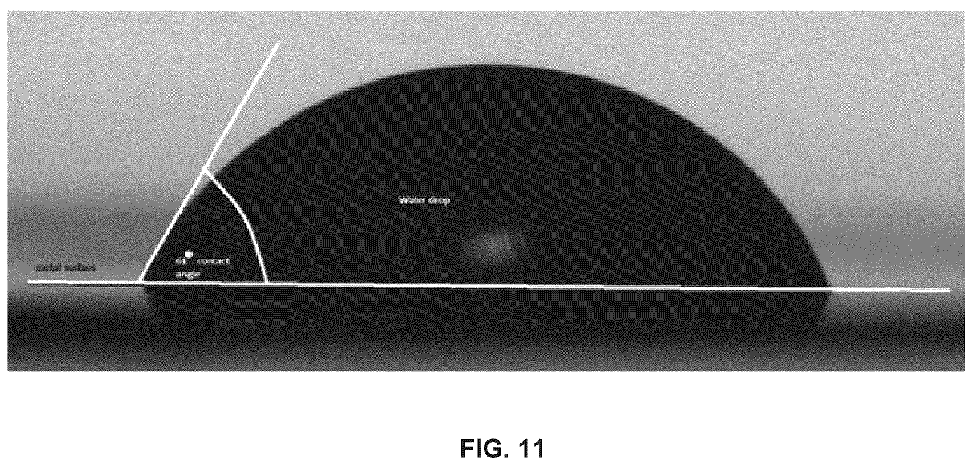

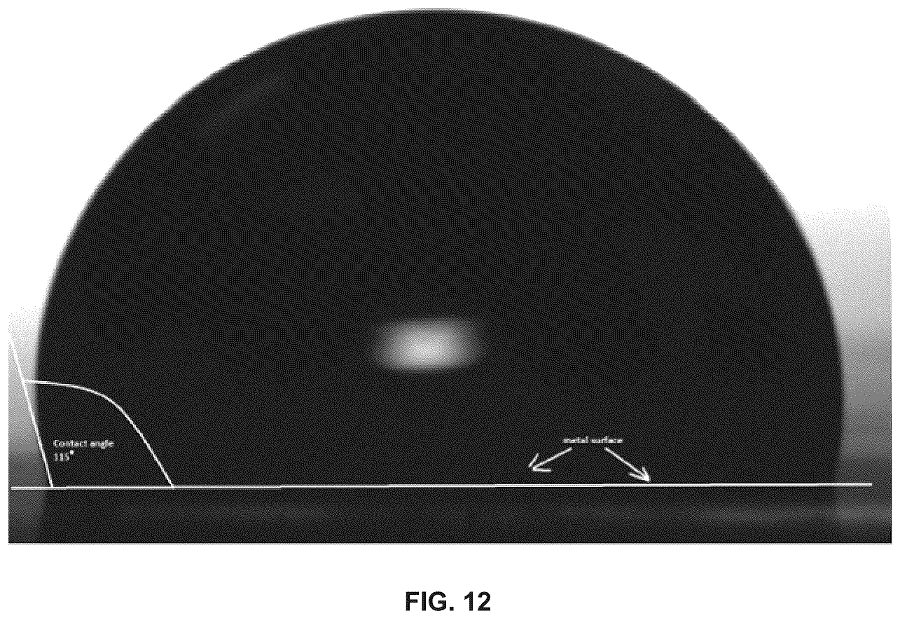

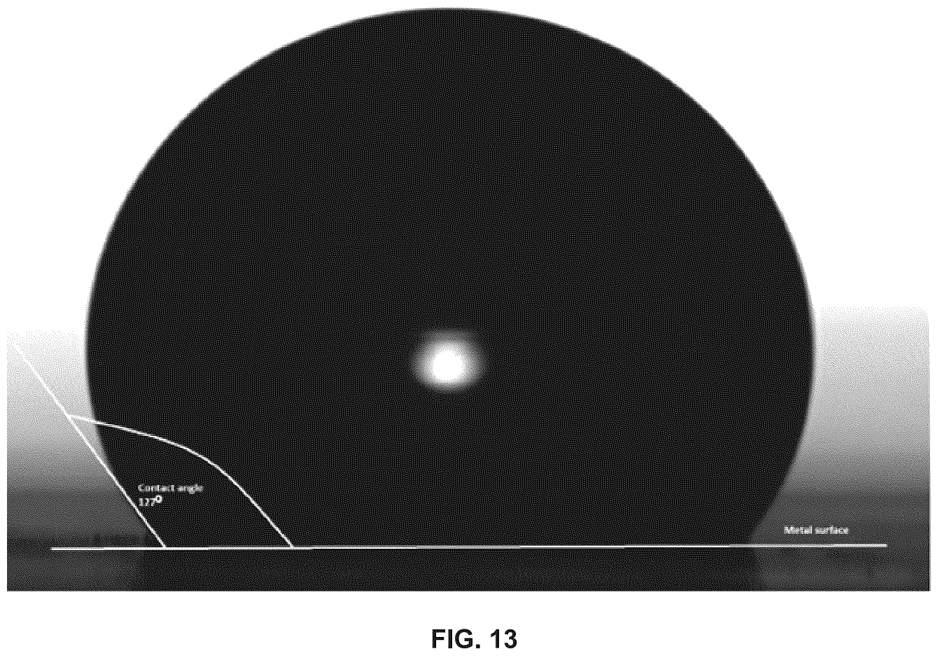

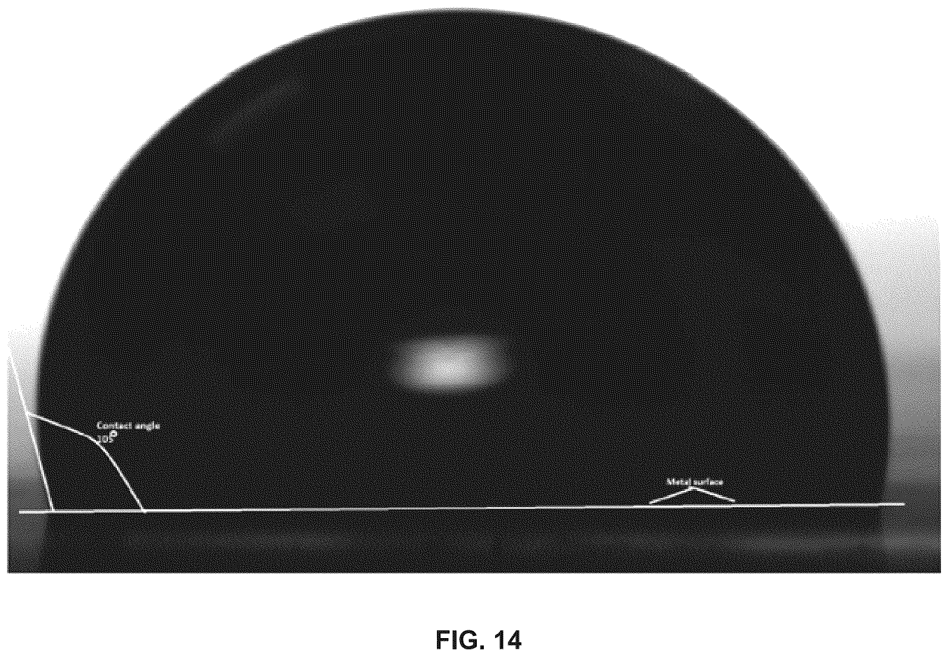

The contact angle of water was measured on the smooth stainless steel substrate as well as the microstructured surfaces of FIGS. 8-10 to evaluate the wettability characteristics of the microstructuring. FIG. 11 is an image showing the contact angle of water on the smooth stainless steel substrate of FIG. 7 and shows that the example resulted in a water contact angle of 61 degrees. FIG. 12 is an image showing the contact angle of water on the first example set of microstructures of FIG. 8 and shows that the example resulted in a water contact angle of 115 degrees. FIG. 13 is an image showing the contact angle of water on the second example set of microstructures of FIG. 9 and shows that the example resulted in a water contact angle of 127 degrees. FIG. 14 is an image showing the contact angle of water on the third example set of microstructures of FIG. 10 and shows that the example resulted in a water contact angle of 105 degrees.

Various examples have been described. These and other examples are within the scope of the following claims.

1. A method for preparing polymer beads, the method comprising:
contacting a first side of a membrane with a phase to be dispersed and contacting a second side of the membrane with a second liquid that is immiscible with the phase to be dispersed, wherein the membrane comprises microstructures formed on the second side of the membrane;
dispersing the phase to be dispersed through a plurality of through holes extending through the membrane into the second liquid to form a plurality of droplets comprising the phase to be dispersed, wherein a shear force is provided at a point of egression of the phase to be dispersed into the second liquid; and
forming polymer beads from the plurality of droplets dispersed in the second liquid.

2. The method of claim 1, wherein the membrane is devoid of any surface coatings applied to the first side and the second side of the membrane.

3. The method of claim 1, wherein the microstructures are configured to increase a contact angle of the phase to be dispersed with the second side of the membrane compared to the contact angle of the phase to be dispersed with the second side of the membrane without the microstructures.

4. The method of claim 1, wherein the microstructures are formed via laser ablation.

5. The method of claim 1, wherein the microstructures comprise a laser-induced periodic surface structure.

6. The method of claim 1, wherein the microstructures comprise a cone-like protrusion.

7. The method of claim 1, wherein the membrane is formed of a metal.

8. The method of claim 1, wherein the second side of the membrane comprising the microstructures exhibits a water contact angle greater than 90 degrees.

9. The method of claim 1, wherein the shear force is provided by displacing the membrane relative to the second volume of liquid.

10. The method of claim 1, wherein the shear force provides a direction of shear substantially perpendicular to a direction of egression of the first volume of liquid.

11. The method of claim 1, wherein:
the membrane comprises from about 100 to about 40,000 through holes per cm² of the membrane; and
each of the plurality of through holes has a diameter within a range of about 1 μm to about 100 μm.

12. The method of claim 1, further comprising a cylindrical-shaped double-walled chamber comprising an outer cylindrical component with a continuous side wall and an inner cylindrical component with a continuous side wall, wherein the continuous side wall of the inner component is spaced inwardly from the continuous side wall of the outer component, and the continuous side wall of the inner component comprises the membrane.

13. The method of claim 1, wherein the polymer beads have a volume average particle diameter from about 10 μm to about 180 μm and a uniformity coefficient of less than 1.3.

14. The method of claim 1, wherein the phase to be dispersed comprises agarose.

15. The method of claim 1, wherein forming polymer beads from the plurality of droplets dispersed in the second liquid comprises polymerizing the plurality of droplets dispersed in the second liquid.

16. A method for preparing spheroidal agarose beads, the method comprising:
contacting a first side of a membrane with an aqueous agarose solution and contacting a second side of the membrane with a continuous phase, wherein the membrane comprises microstructures formed on the second side of the membrane and the second side of the membrane is devoid of any surface coatings;
dispersing the aqueous agarose solution through a plurality of through holes extending through the membrane into the continuous phase to form a plurality of agarose droplets, wherein a shear force is provided at a point of egression of the aqueous agarose solution into the continuous phase; and
inducing gelation in the plurality of agarose droplets dispersed in the continuous phase.

17. The method of claim 16, wherein the microstructures are configured to increase a contact angle of the aqueous agarose solution with the second side of the membrane compared to the contact angle of the aqueous agarose solution with the second side of the membrane without the microstructures.

18. The method of claim 16, wherein:
the membrane is formed of a metal; and
the microstructures comprise a laser-induced periodic surface structure and/or a cone-like protrusion.

19. A membrane for use in a membrane emulsification processes, the membrane comprising:
a membrane body having a first side configured to contact a phase to be dispersed and a second side opposite the first side configured to contact a second liquid that is immiscible with the phase to be dispersed, the membrane body being devoid of any surface coatings;
microstructures formed on the second side of the membrane body; and
a plurality of through holes extending through the membrane body, the plurality of through holes being configured for dispersing the phase to be dispersed into the second liquid.

20. The membrane of claim 19, wherein
the plurality of through holes comprises from about 100 to about 40,000 through holes per cm² of the membrane body; and
each of the plurality of through holes has a diameter within a range of about 1 μm to about 100 μm, preferably from about 20 μm to about 60 μm.

21. The membrane of claim 19, wherein:
the membrane body is formed of a metal;
the microstructures comprise a laser-induced periodic surface structure and/or a cone-like protrusion.
